(19) United States
(12) Patent Application Publication
(10) Pub. No.: US 2015/0096154 A1
(43) Pub. Date: Apr. 9, 2015

(54) Snap Hook

(71) Applicant: Buckingham Manufacturing Company, Inc., Binghamton, NY (US)

(72) Inventor: DeForest C. Canfield, Oxford, NY (US)

(73) Assignee: Buckingham Manufacturing Company, Inc., Binghamton, NY (US)

(21) Appl. No.: 14/506,725

(22) Filed: Oct. 6, 2014

Related U.S. Application Data
(60) Provisional application No. 61/886,981, filed on Oct. 4, 2013.

(51) Int. Cl. A62B 35/00; F16B 45/02

(52) U.S. Cl. CPC A62B 35/0075; F16B 45/02
USPC 24/517

(57) ABSTRACT

A snap hook essentially including a main body having an arcuate portion that transition between a spine and a gate latching end, wherein the interior edges of the arcuate portion are radiused. The snap-hook further includes a gate that is pivotally attached to the main body, and a lock that pivotally mounts to the main body and in securing relation to the gate to prevent the gate from opening unless and until the lock is manually, pivotally moved by depressing on its end. The gate latching end of the main body includes a notch for receiving the end of the gate wherein the notch includes an inwardly directed upper, extension piece that will engage the end of the gate if it is inadvertently pushed towards an open position.

### REFERENCE TO RELATED APPLICATION

The present application relates and claims priority to U.S. Provisional Patent Application Ser. No. 61/886,981, filed Oct. 4, 2013, the entirety of which is hereby incorporated by reference.

### BACKGROUND

1. Field of Invention

The present invention relates to hooks, and more particularly to snap hooks used by utility linemen.

2. Background of Art

Snap hooks used by utility linemen provide a safety mechanism when climbing poles and working on a utility line. The snap-hooks are used to tether a linemen or equipment to a conductor or angle iron that is attached to a pole/tower/other structure. In the event of a fall, the snap hook will prevent its load from falling farther than the length of the rope or lanyard used as the tether.

Conventional snap-hooks comprise a main body with an oval opening, a spring loaded gate that pivotally mounts to the main body and permits the oval opening to become accessible or closed, and a lock that prevents inadvertent opening of the gate. The gate is preferably mounted such that it is biased to open in to the oval opening, as opposed to outside the opening. In addition, the end of the gate engages a U-shaped notch formed in the end of the main body where it closes. As a load is applied to the snap-hook, depending on orientation, some of the load may be borne by the gate. Thus, having it swing inwardly instead of outwardly prevents the load from pushing the gate open and thereby releasing the load. Moreover, the notched end further serves to securely engage the gate with the main body.

With conventional snap-hooks, the arcuate portion of the main body that transitions between the main spine and the end where the gate engages often becomes engaged with the conductor that the snap-hook latches. When a load is applied, the edges of the arcuate portion will bite or cut into the conductor, potentially causing damage to the conductor.

3. Objects and Advantages

It is therefore a primary object and advantage of the present invention to provide a snap hook with a main body whose arcuate portion does not bite or cut into a conductor.

It is another object and advantage of the present invention to provide a snap hook that more securely retains the gate to the main body when closed.

It is a further object and advantage of the present invention to provide a snap hook that includes a larger opening in order to engage larger objects.

Other objects and advantages of the present invention will in part be obvious and in part appear hereinafter.

### SUMMARY OF THE INVENTION

In accordance with the foregoing objects and advantages, the present invention provides a snap hook essentially comprising a main body having an arcuate portion that transition between a spine and a gate latching end, wherein the interior edges of the arcuate portion are radiused. The snap-hook further comprises a gate that is pivotally attached to the main body, and a lock that pivotally mounts to the main body and in securing relation to the gate to prevent the gate from opening unless and until the lock is manually, pivotally moved by depressing on its end. The gate latching end of the main body includes a notch for receiving the end of the gate wherein the notch includes an inwardly directed upper, extension piece that will engage the end of the gate if it is inadvertently pushed towards an open position.

### BRIEF DESCRIPTION OF THE DRAWINGS

The present invention will be more fully understood and appreciated by reading the following Detailed Description in conjunction with the accompanying drawings, in which:

FIG. 1 is a front elevation view of an embodiment of the present invention with interior details being shown.

FIG. 2 is a cross-sectional view taken along line 2-2 of FIG. 1.

FIG. 3 is a perspective view of an embodiment of the present invention.

FIG. 4 is a front elevation view of the main body of an embodiment of the present invention.

FIG. 5 is a front elevation view of the gate of an embodiment of the present invention.

FIG. 6 is a front elevation view of the gate lock mechanism of an embodiment of the present invention.

### DETAILED DESCRIPTION

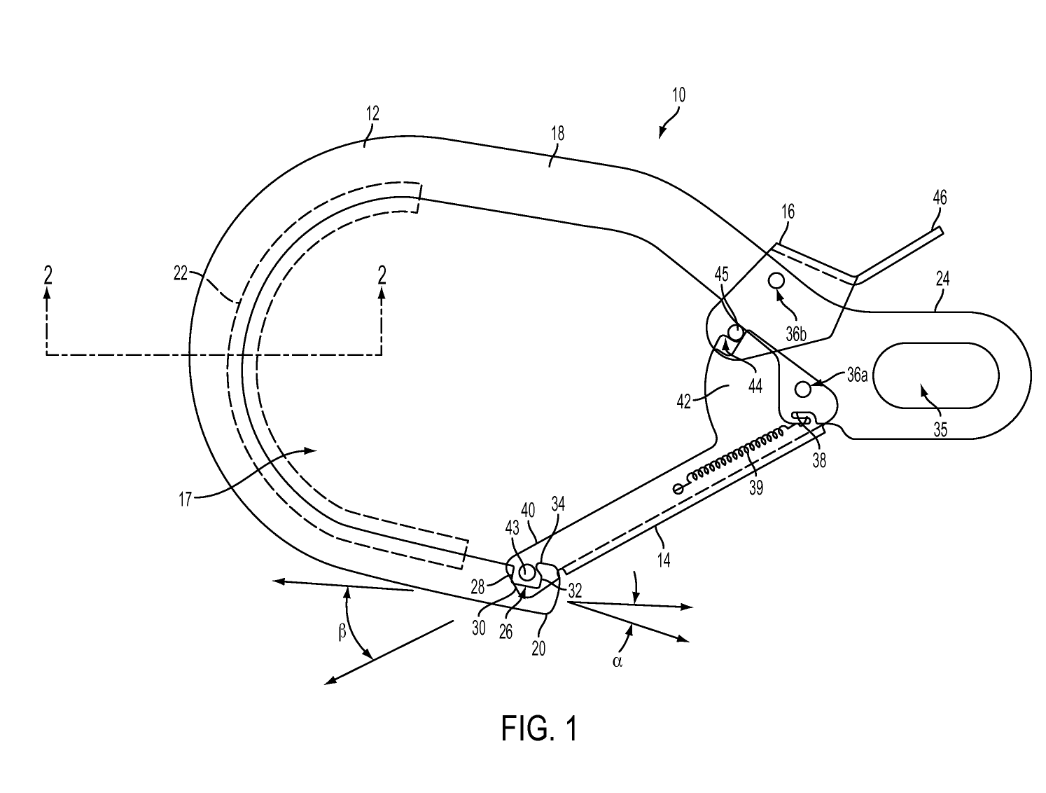

Referring now to the drawings, wherein like reference numerals refer to like parts throughout, there is seen in FIG. 1 a snap-hook designated generally by reference numeral 10. Snap-hook 10 comprises three principal components: a main body 12, a gate 14 pivotally mounted to main body 12, and a gate lock 16 pivotally attached to main body 12 for selective movement into and out of engagement with gate 14.

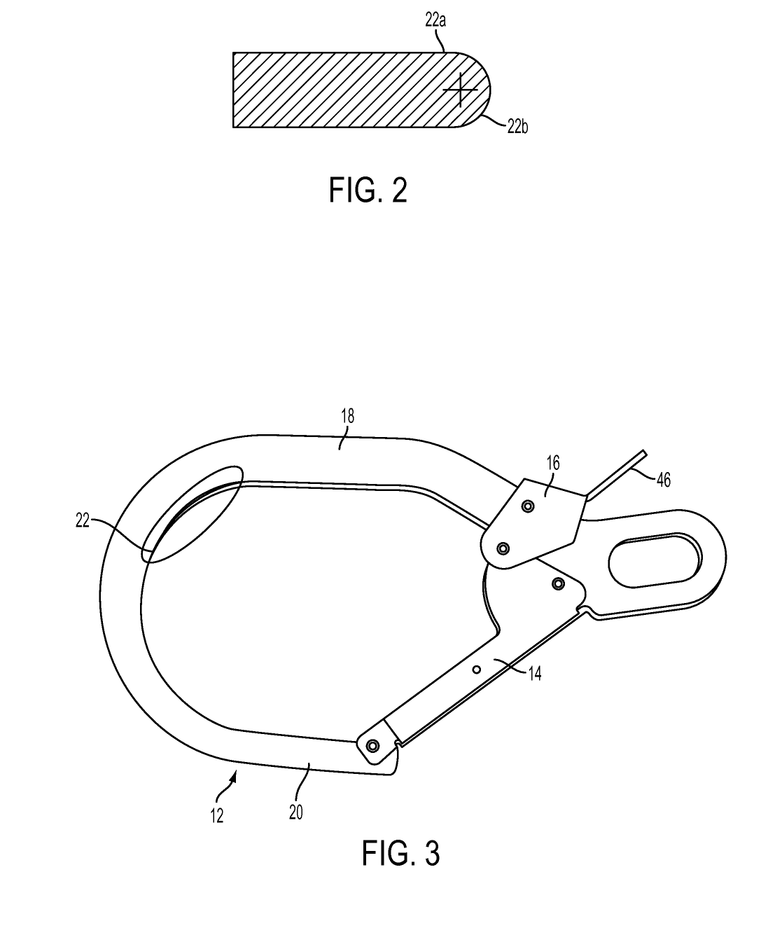

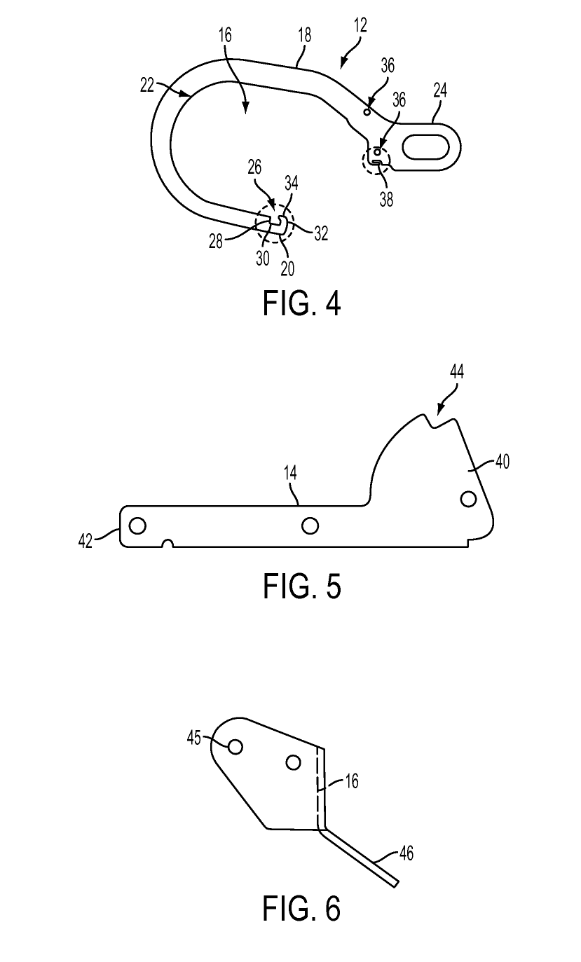

With regard to main body 12, it defines an oval opening 17 by way of a spine region 18, a gate engaging end 20, an arcuate region 22 that extends between spine region 18 and gate engaging end 20, and a mounting end 24 positioned at the terminal end of spine region 18. As shown in FIG. 2, the interior edges 22a and 22b of arcuate region 22 are radiused in order to remove any sharp edges that can cut or bite into a conductor to which snap-hook 10 may be attached.

The gate engaging end 20 of main body 12 comprises a notch 26 formed therein for receiving a terminal end of gate 14. Notch 26 is defined by a straight rear wall 28, a flat bottom 30 a straight front wall 32 that extends upwardly from bottom 30, and a hooked extension 34 that extends inwardly from the top of front wall 32 towards rear wall 28 and in spaced relation above bottom 30. This hooked extension 34, as will be more fully described hereinafter, serves to prevent gate 14 from becoming inadvertently opened relative to main body 12 when gate 14 is placed under tension.

The mounting end 24 of main body 12 comprises an oval opening 35 through which rope or a clip may pass to attach snap-hook 10 to a belt or other carrying mechanism (not shown). It further comprises drilled openings 36a and 36b for receiving fasteners for attaching gate 14 and gate lock 16, respectively, to main body 12. Finally, mounting end 24 comprises an outwardly directed hooked extension 38 that serves to anchor a spring 39 that provides the biasing force to forcibly close gate 14 absent an external opening force being directed thereto, as is conventional with snap-hooks.

With regard to gate 14, it comprises a mounting end 40 and a closing end 42 that includes a pin 43 that extends thereacross and moves into and out of engagement with notch 26. When gate 14 is placed under tension (such as when a load is applied to it when closed), pin 43 will ride within notch 26. Due to the (negative) angle β at which gate 14 extends relative to the horizontal, the pin 43 will ride along the hooked extension 34 which prevents it from becoming disengaged and resulting in gate 14 opening.

Gate 14 mounts to the mounting end 24 of main body 12 via a rivet or other conventional fastener that passes through opening 36a. An arcuate slot 44 is formed at the closing end 42 and is shaped to receive a locking pin 45 that forms a part of gate lock 16 and extends transversely across the slot 44.

With regard to gate lock 16, it comprises the locking pin 45 that engages the arcuate slot 44 in gate 14 to lock it in its closed position. Gate lock 16 attaches to main body 12 at mounting end 24 via a rivet or other conventional fastener passing through opening 36b, and is selectively, manually, pivotally movable by a user depressing on the unlocking surface 46. Depression of surface 46 causes pivotal movement of gate lock 16 and consequently pin 45 out of engagement with gate 14, thereby freeing gate 14 to be moved from a closed to an open position where it can be placed over a conductor or an angle iron or other anchorage to secure a lineman or other load.

In order to engage larger diameter conductors or angle irons, as compared to conventional snap-hooks, the gate engaging end 20 of main body 12 extends at a slightly negative angle α of about 5° relative to the horizontal. Conventional snap hooks extend at a slightly positive angle relative to the horizontal. With this negative angle α, gate 14 extends at a slightly larger angle β or about 35° to 45° relative to horizontal as compared to conventional snap-hooks which extended at about a 20° angle. This angular change from convention necessitated the structural change of adding hooked extension 34 to prevent inadvertent opening of gate 14 when placed under tension (conventional snap-hooks do not include a hooked extension 34). In addition, the angular modifications also increased the opening space accommodated by gate 14 without increasing the overall size from conventional snap-hooks.

What is claimed is:

1. A snap hook, comprising:
a. a main body comprising an opening defined collectively by a spine region, a gate engaging end, an arcuate region that extends between said spine region and said gate engaging end, and a mounting end positioned at a terminal end of said spine region, wherein at least a portion of said arcuate region includes inwardly directed edges that are rounded;
b. a gate pivotally mounted to said main body and movable between open and closed positions relative to said opening; and
c. a gate lock pivotally attached to said main body for selective movement into and out of engagement with said gate.

2. The snap hook according to claim 1, wherein said gate engaging end extends at a negative angle relative to the horizontal.

3. The snap hook according to claim 2, wherein said negative angle is approximately 5°.

4. The snap hook according to claim 1, wherein said gate extends at an angle in the range of about 35° to about 45° relative to horizontal when in its said closed position.

5. The snap hook according to claim 1, wherein said gate engaging end of said main body comprises a notch formed therein for receiving a terminal end of said gate.

6. The snap hook according to claim 5, wherein said notch is defined by a straight rear wall, a flat bottom, a straight front wall that extends upwardly from said bottom, and a hooked extension that extends inwardly from the top of said front wall towards said rear wall and in spaced relation above said bottom.

7. The snap hook according to claim 6, wherein said gate comprises a mounting end and a closing end that includes a pin that extends thereacross and moves into and out of engagement with said notch.

8. The snap hook according to claim 7, wherein said pin rides along said hooked extension, thereby preventing it from becoming disengaged and resulting in said gate opening.

9. The snap hook according to claim 1, wherein said gate comprises a mounting end and a closing end, said gate being pivotally connected to said main body at said mounting end, and wherein said mounting end comprises an arcuate notch formed therein.

10. The snap hook according to claim 9, wherein said gate lock comprises a locking pin that is movable into and out of engagement with said arcuate notch formed in said mounting end of said gate.

11. A snap hook, comprising:
a. a main body comprising an opening defined collectively by a spine region, a gate engaging end, an arcuate region that extends between said spine region and said gate engaging end, and a mounting end positioned at a terminal end of said spine region, wherein said gate engaging end extends at a negative angle relative to the horizontal and wherein said gate extends at an angle in the range of about 35° to about 45° relative to horizontal when in its said closed position;
b. a gate pivotally mounted to said main body and movable between open and closed positions relative to said opening; and
c. a gate lock pivotally attached to said main body for selective movement into and out of engagement with said gate.

12. The snap hook according to claim 11, wherein said gate engaging end of said main body comprises a notch formed therein for receiving a terminal end of said gate.

13. The snap hook according to claim 12, wherein said notch is defined by a straight rear wall, a flat bottom, a straight front wall that extends upwardly from said bottom, and a hooked extension that extends inwardly from the top of said front wall towards said rear wall and in spaced relation above said bottom.

14. The snap hook according to claim 13, wherein said gate comprises a mounting end and a closing end that includes a pin that extends thereacross and moves into and out of engagement with said notch.

15. The snap hook according to claim 14, wherein said pin rides along said hooked extension, thereby preventing it from becoming disengaged and resulting in said gate opening.

16. The snap hook according to claim 11, wherein said gate comprises a mounting end and a closing end, said gate being pivotally connected to said main body at said mounting end, and wherein said mounting end comprises an arcuate notch formed therein.

17. The snap hook according to claim 16, wherein said gate lock comprises a locking pin that is movable into and out of engagement with said arcuate notch formed in said mounting end of said gate.
